(19) United States
(12) Patent Application Publication
(10) Pub. No.: US 2026/0174070 A1
(43) Pub. Date: Jun. 25, 2026

(54) Holder for assisting in transferring fishing line to a reel

(71) Applicant: Réal Tardy, Laval (CA)

(72) Inventor: Réal Tardy, Laval (CA)

(21) Appl. No.: 18/988,246

(22) Filed: Dec. 19, 2024

(51) Int. Cl. A01K 89/00

(52) U.S. Cl. CPC A01K 89/003

(57) ABSTRACT

A holder for assisting in transferring fishing line held on a spool to a reel supported by a fishing rod, the holder comprising: a support shaft for supporting the spool so that the spool and the support shaft are jointly axially rotatable; and a brake operatively coupled to the support shaft for applying a rotational drag to the support shaft when the support shaft is rotated; wherein the brake includes a disk jointly rotatable with the support shaft and an engagement member operatively coupled to the disk to resist rotation of the disk.

### FIELD OF THE INVENTION

The present invention relates to the general field of fishing, and, more particularly, to a holder for assisting in transferring fishing line held on a spool to a reel.

### BACKGROUND

Store-bought fishing line needs to be transferred to a reel before it can be used. Smooth operation of the reel requires that the fishing line be under tension when first rolled on the reel. Therefore, one cannot simply attach the line to the reel and transfer from a spool laying on a table or on the ground. In addition, different types of fishing line require different tensions. Fishing line can be transferred by the shop where the line is bought, but this service costs money, and such transfers can become expensive for serious fishing enthusiasts.

Thus, there is a need on the market for an improved manner of transferring fishing line to a reel. An object of the present invention is to provide such improved manners.

### SUMMARY OF THE INVENTION

In a broad aspect, there is provided a holder for assisting in transferring fishing line held on a spool to a reel supported by a fishing rod, the holder comprising: a support shaft for supporting the spool so that the spool and the support shaft are jointly axially rotatable; and a brake operatively coupled to the support shaft for applying a rotational drag to the support shaft when the support shaft is rotated; wherein the brake includes a disk jointly rotatable with the support shaft and an engagement member operatively coupled to the disk to resist rotation of the disk.

There may also be provided a holder wherein the engagement member mechanically engages the disk.

There may also be provided a holder wherein the disk is provided with a corrugated surface defining corrugations and the engagement member engages the corrugated surface.

There may also be provided a holder wherein the engagement member is urged towards the corrugated surface.

There may also be provided a holder wherein the engagement member is biased towards the corrugated surface by a biasing element.

There may also be provided a holder wherein a biasing force biasing the engagement member towards the corrugated surface is adjustable.

There may also be provided a holder wherein the engagement member is mounted to a support member, the engagement member being movable relative to the support member perpendicularly to the corrugated surface to follow the corrugations as the disk is rotated with the support member remaining at a fixed distance from the disk.

There may also be provided a holder further comprising an adjustment member mounted to the support member and a biasing element extending between the adjustment member and the engagement member, wherein moving the adjustment member relative to the support member changes a biasing force exerted by the biasing element on the engagement member and biasing the engagement member towards the corrugated surface.

There may also be provided a holder wherein the corrugated surface is a first corrugated surface, the disk further defining a second corrugated surface having different corrugation characteristics than the first corrugated surface, the support member being movable relative to the disk to engage the engagement member with a selected one of the first and second corrugated surfaces.

There may also be provided a holder wherein the disk is mounted in an enclosure, the enclosure defining a groove receiving the support member such that the support member is movable along the groove to move the engagement member in contact with the selected one of the first and second corrugated surfaces.

There may also be provided a holder wherein the engagement member includes a pin, the support member includes a sleeve defining a passageway extending therethrough, the passageway being at least in part threaded, the biasing element includes a coil spring and the adjustment member includes a threaded section configured for threadedly engaging the passageway, the pin and adjustment members being mounted in the sleeve at opposed sleeve ends thereof with the coil spring provided therebetween.

There may also be provided a holder wherein the disk defines a pair of parallel side surfaces and an edge surface extending therebetween, the corrugated surface being defined on one of the side surfaces.

There may also be provided a holder wherein the disk defines a pair of parallel side surfaces and an edge surface extending therebetween, the corrugated surface being defined on the edge surface.

There may also be provided a holder further comprising a mount for mounting the holder to the fishing rod.

There may also be provided a holder wherein the mount includes a clamp.

There may also be provided a holder further comprising a spool lock mountable to the support shaft for locking the spool thereto.

There may also be provided a holder wherein the support shaft includes a threaded section and the spool lock is screwable on the threaded section.

There may also be provided a holder wherein the spool lock further includes a release mechanism for disengaging the spool lock from the threaded section and allowing longitudinal movement of the spool lock along the threaded section.

There may also be provided a holder wherein the disk defines a recessed portion, the engagement member being selectively movable between adjacent the corrugated surface and adjacent the recessed portion, wherein the recessed portion is configured such that the engagement member is unbiased towards the disk when adjacent the recessed portion.

There may also be provided a holder wherein the recessed portion is configured such that the engagement member is disengaged from the disk when adjacent the recessed portion.

Advantageously, the proposed holder allows transfer of fishing line at home, at no additional cost once it has been bought. In addition, adjusting the amount of friction exerted in the disk allows one to adjust the tension under which the fishing line is spooled.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates an embodiment of a holder, according to the present invention;

FIG. 2, in an alternative perspective view, illustrates the holder shown in FIG. 1;

FIG. 3, in an exploded perspective view, illustrates the holder shown in FIG. 1;

FIG. 4, in side elevation view, illustrates the holder shown in FIG. 1;

FIG. 5, in an alternative side elevation view, illustrates the holder shown in FIG. 1;

FIG. 6, in a rear elevation view, illustrates the holder shown in FIG. 1;

FIG. 7, in a front elevation view, illustrates the holder shown in FIG. 1;

FIG. 8, in a top elevation view, illustrates the holder shown in FIG. 1;

FIG. 9, in a bottom elevation view, illustrates the holder shown in FIG. 1;

FIG. 10, in a perspective exploded view, illustrates a release mechanism for disengaging a spool lock from a threaded section, all part of the holder shown in FIG. 1;

FIG. 11, in an alternative perspective exploded view, illustrates the release mechanism of FIG. 19;

FIG. 12, in a partial perspective view, illustrates an alternative embodiment of a holder according to the present invention;

FIG. 13 in a perspective view with parts removed, illustrates a brake part of the holder of FIG. 12;

FIG. 14, in a partial perspective view, illustrates another alternative embodiment of a holder according to the present invention;

FIG. 15 in a perspective view with parts removed, illustrates a brake part of the holder of FIG. 14;

FIG. 16, in a side cut-away view, illustrates an assembly supporting an engagement member part of the holder of FIG. 1;

FIG. 17, in a partial side cut-away view, illustrates the brake part of the holder of FIG. 14; and

FIG. 18, in a perspective environmental view, illustrates the holder of FIG. 1 used to transfer a fishing line from a spool to a reel of a fishing rod.

### DETAILED DESCRIPTION

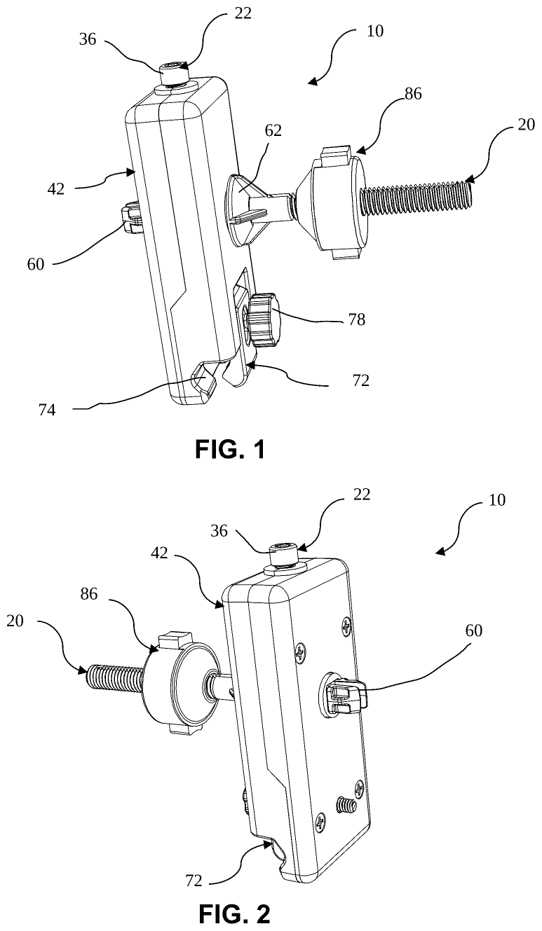

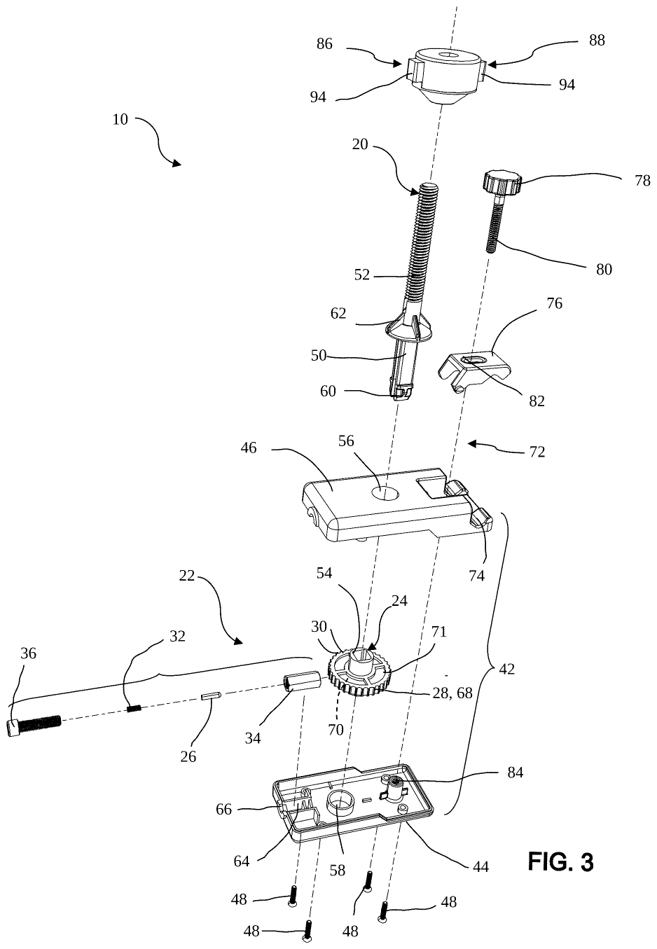

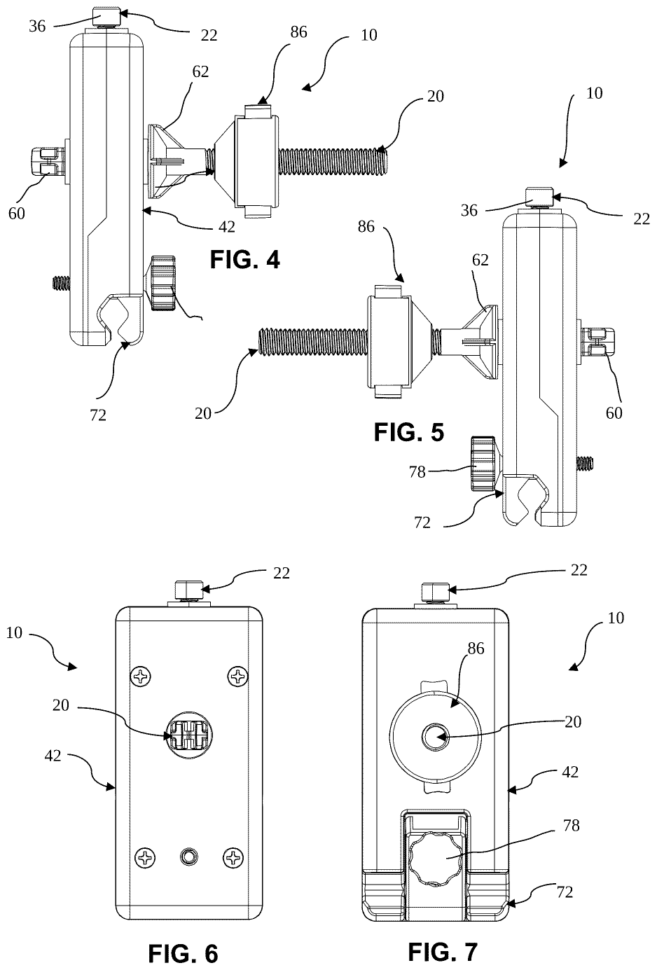

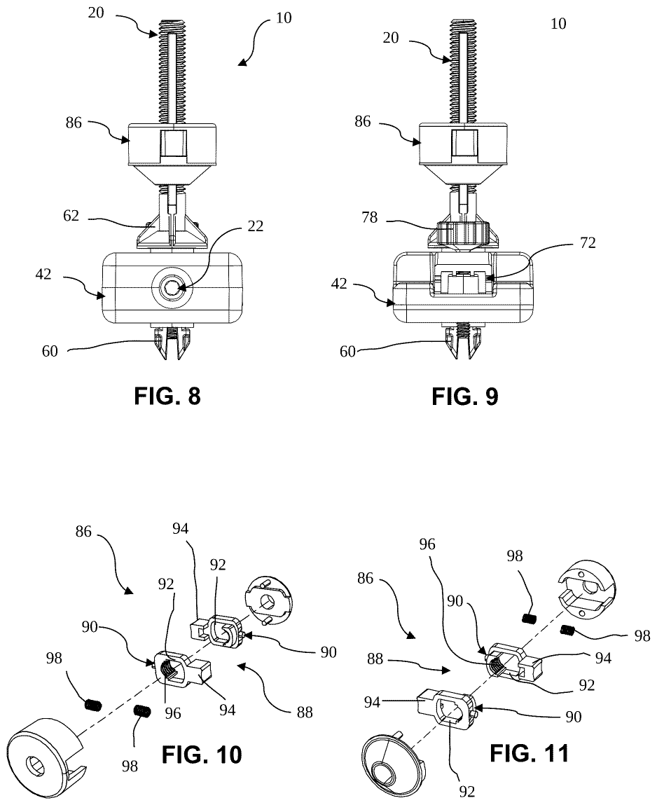

FIGS. 1 to 11 and 18 collectively illustrate an embodiment of a holder 10 for assisting in transferring fishing line 12 held on a spool 14 to a reel 16 supported by a fishing rod 18, as seen in FIG. 18. Referring for example to FIG. 3, the holder 10 includes a support shaft 20 for supporting the spool 14 (not shown in FIG. 3) so that the spool 14 and the support shaft 20 are jointly axially rotatable and a brake 22 operatively coupled to the support shaft 20 for applying a rotational drag to the support shaft 20 when the spool 14 is rotated. Therefore, when the holder 10 is mounted to the fishing rod 18 and used to transfer the fishing line 12 from the spool 14 to the reel 16, the brake 22 creates a tension in the fishing line 12 by resisting rotation of the spool 14. In some embodiments, as described in further details below, the tension is adjustable by changing the magnitude of the rotation drag exerted by the brake 22.

In a specific embodiment of the invention, the brake 22 includes a disk 24 jointly rotatable with the support shaft 20 and an engagement member 26 operatively coupled to the disk 24 to resist rotation of the disk 24. Typically, the engagement member 26 mechanically engages the disk 24 to create the rotational drag. For example, the disk is provided with a corrugated surface 28 defining corrugations 30 and the engagement member 26 engages the corrugated surface 28, thereby creating a resistance to rotation of the disk 24. However, in alternative embodiments, the engagement member 26 frictionally engages any other type of surface on the disk 24 to create the drag.

In some embodiments, the engagement member 26 is urged towards the corrugated surface 28. For example, the engagement member 26 is biased towards the corrugated surface 28 by a biasing element 32. In some embodiments, a biasing force biasing the engagement member 26 towards the corrugated surface 28 is adjustable.

In a typical embodiment, the engagement member 26 is mounted to a support member 34 with the engagement member 26 being movable relative to the support member 34 perpendicularly to the corrugated surface 28 to follow the corrugations 30 as the disk 24 is rotated with the support member 34 remaining at a fixed distance from the disk 24.

When the drag is adjustable, this adjustment may be performed using an adjustment member 36 mounted to the support member 34 with the biasing element 32 extending between the adjustment member 36 and the engagement member 26. Moving the adjustment member 36 relative to the support member 34 changes a biasing force exerted by the biasing element 32 on the engagement member 26 and biasing the engagement member 26 towards the corrugated surface 28. This is caused by a change in length of the biasing element 32, which in turn changes the biasing force.

Referring for example to FIG. 16, in a specific embodiment of the invention, the engagement member 26 takes the form of a pin, the support member 34 takes the form of a sleeve defining a passageway 38 extending therethrough, the passageway 38 being at least in part threaded, the biasing element 32 takes the form of a coil spring and the adjustment member 36 includes a threaded section 40 configured for threadedly engaging the passageway 38. For example, the support member 34 takes the form of an elongated nut and the adjustment member 36 takes the form of a bolt or screw having threads compatible with the threads of the nut. The pin and adjustment member 36 are mounted in the sleeve at opposed sleeve ends thereof with the coil spring provided therebetween. This whole assembly is positioned adjacent the disk 24, so that the pin protrudes partially from the sleeve and abuts against the corrugated surface 28. The coil spring pushes then pin towards the disk 24, and the screw or bolt is usable to adjust the biasing force by varying the length of the coil spring.

Returning to FIG. 3, in some embodiments, the brake 22 and support shaft 20 are mounted to a casing 42. For example, the casing 42 includes first and second shells 44 and 46 held together by screws 48. Most of the brake 22 is enclosed in the casing 42, with only the adjustment member 36 protruding therefrom. The support shaft 20 includes a disk supporting section 50 inserted in the casing 42 to which the disk 24 is mounted for joint rotation, and a spool supporting section 52 protruding from the casing 42. For example, the disk 24 defines a central aperture 54 extending therethrough and receiving the disk supporting section 50 therethrough. The central aperture 54 and the disk supporting section 50 have similar non-circular transversal cross-sectional configurations to couple the disk 24 and the support shaft 20 to each other, for example a square transversal cross-sectional configuration. The casing 42 defines at least one shaft aperture 56 for receiving the support shaft 20 therethrough.

In some embodiments, another shaft aperture 58 is also present in the casing 42, opposed to the shaft aperture 56. In such embodiments, the disk supporting section 50 may terminate with a radially collapsible clip 60 protruding radially outwardly from the disk supporting section 50 when released. Also, a flange 62 may extend between the disk supporting and spool supporting sections 50 and 52. Therefore, when the disk supporting section 50 has been fully inserted through the shaft apertures 56 and 58 with the clip 60 protruding from the casing 42, the support shaft 20 is maintained secured to the casing 42 as the latter is maintained between the clip 60 and flange 62.

The casing 42 also defines a recess 64 for receiving the support member 34 and configured so that the latter is maintained inside the casing 42 in a fixed position and orientation, and an adjustment member aperture 66 leading to the recess 64 for receiving the adjustment member 36 therethrough.

The disk 24 defines a pair of parallel side surfaces 71 (only one of which is visible in FIG. 3) and an edge surface 68 extending therebetween. In the embodiment of the disk shown in FIG. 3, the corrugated surface 28 is defined on the edge surface 68. In this case, the engagement member 26 is biased radially towards the disk 24. In alternative embodiments, as seen for example in the embodiment of FIGS. 14 and 15, the corrugated surface 28″ is defined in one of the side surfaces 71″. In this case, the engagement member 26″ is biased axially towards the disk 24″.

In some embodiments, the holder 10 includes a mount 72 for mounting the holder 10 to the fishing rod 18, as seen in FIG. 18. As better seen for example in FIGS. 1 and 3 taken collectively, the mount 72 may take the form of a clamp defined by a recess 74 formed in the casing 42 and a clamping member 76 reversibly mountable to the casing 42 so that the clamping member 76 faces the recess 74 when operatively mounted to the casing 42. When the fishing rod 18 is received in the recess 74 and the clamping member 76 is mounted to the casing 42, the fishing rod 18 is clamped between the casing 42 and the clamping member 76, which allows one to securely mount the holder 10 to the fishing rod 18. The clamping member 76 may be reversibly mounted to the casing 42 through a knob 78 including a threaded shaft 80 configured to engage the clamping member 76 through a mounting aperture 82 extending therethrough and screwable in a threaded aperture 84 defined by the casing 42.

In some embodiments, the holder 10 includes a spool lock 86 mountable to the support shaft 20 for locking the spool 14 thereto. For example, the spool supporting section 52 is threaded, and the spool lock 86 is screwable on the spool supporting section 52. In use, as seen in FIG. 18, the spool 14 is mounted to the support shaft 20 and the spool lock 86 is screwed until the spool 14 is maintained fixedly on the support shaft 20 by being pinched between the flange 62 (not shown in FIG. 18) and the spool lock 86.

In some embodiments, the spool lock 86 further includes a release mechanism 88 for disengaging the spool lock 86 from the spool supporting section 52 and allowing longitudinal movement of the spool lock 86 therealong. For example, referring to FIGS. 10 and 11, the release mechanism 88 takes the form of a pair of release members 90 located adjacent each other and each movable radially in a reciprocating member inside the spool lock 86. Each release member 90 defines a through aperture 92 of generally oval shape and a push button 94. The through apertures 92 are in register with each other, so that they receive the support shaft 20 therethrough when the spool lock 86 is mounted to the support shaft 20. The push buttons 94 protrude radially outwardly from the remainder of the spool lock 86 opposite each other and are usable by an intended user to actively move the push buttons 94 radially towards the axis of the support shaft 20. The through apertures 92 each define an internally threaded surface 96 opposed to the push buttons 94 and extending about 180 degrees around an arc segment shaped portion of the through apertures 92. The remainder of the internal surface of the through apertures 92 is not threaded. Biasing elements, for example coil springs 98, bias the release members 90 so that their push buttons 94 are moved radially outwardly away from each other.

Therefore, when the push buttons 94 are released and the supporting section 52 is inserted through the through apertures 92, the threaded surfaces 96 engage the supporting section 52 and allows one to screw the spool lock 86 on the supporting section 52. When one wants to release the spool lock 86, the two push buttons 94 are pushed, which disengages the threaded surfaces 96 from the supporting section 52, and allows one to simple pull the spool lock out from the supporting section, without requiring one to unscrew the spool lock 86.

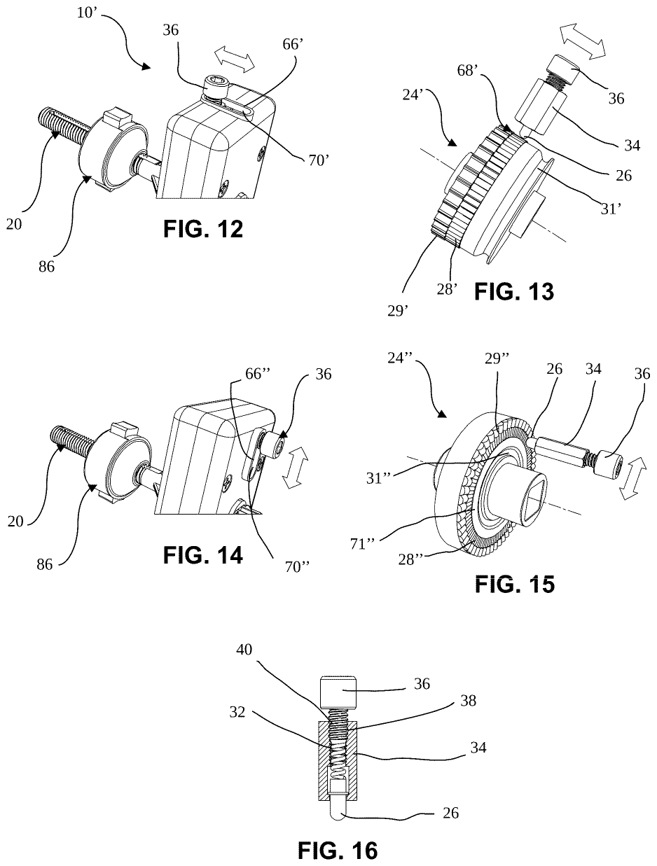

With reference to FIGS. 12 to 15, in some embodiments of the holder 10′ and 10″, the disk 24′ or 24″ defines two corrugated surfaces 28′, 29′ or 28″, 29″, typically located side-by-side relative to each other and having different corrugation characteristics. For example, and non-limitingly, the corrugations may be deeper in one of the corrugated surface 29′ or 29″ than in the other one of the corrugated surfaces 28′ or 28″, which changes the resistance provided by the brake 24′ or 24″, depending on which one of the corrugated surface 28′, 28″, 29′ or 29″ is engaged. In these embodiments, the support member 34 is movable relative to the disk 24′ or 24″ so that the engagement member 26 is able to selectively engage either one of the corrugated surfaces 28′, 29′ or 28″, 29″. In the holder 10′, the corrugated surfaces 28′ and 29′ are located on the edge surface 68′, while in the holder 10″, the corrugated surfaces 28″ and 29″ are located on one of the side surfaces 71″. In alternative embodiments of the invention, more than two corrugated surfaces having different corrugation characteristics are provided side-by-side.

To allow movements of the support member 34′, in the holders 10′ and 10″, the circular adjustment member aperture 66 is replaced by an elongated adjustment member aperture 66′ or 66″ leading to a groove 70′ or 70″ receiving the support member 34′ such that the support member 34 is movable along the groove 70 or 70′ to move the engagement member 26 in contact with a selected one of the first and second corrugated surfaces 28′ or 28″ and 29′ or 29″.

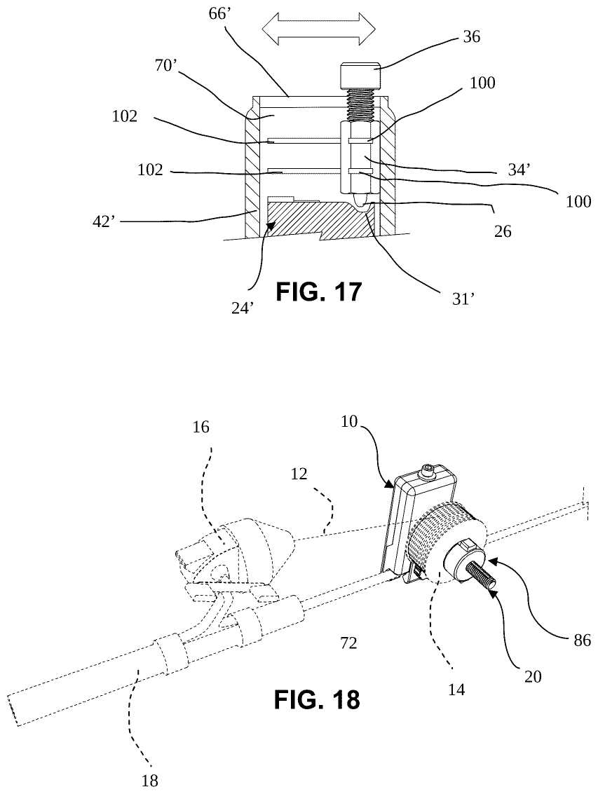

FIG. 17 illustrates an example of such a groove 70′ in greater details, the groove 70″ having similar characteristics. The groove 70′ extend between the adjustment member aperture 66′ and the disk 24′ and is configured to retain the support member 34′ thereinto as the latter is moved longitudinally therealong. To that effect, the support member 34′ may define a pair of circumferential ridges 100 engaging corresponding elongated creases 102 extending in the casing 42′. The creases 102 are configured to prevent movements of the support member 34′ away or towards the disk 24′, but to allow movements of the support member 34′ axially relative to the disk 24′. In alternative embodiments, any other suitable manner of retaining the support member 34′ in the groove 70′ may be used.

In some embodiments, the disk 24′ or 24″ defines a recessed portion 31′ or 31″ located side-by-side relative to the first and second corrugated surfaces 28′ or 28″ and 29′ or 29, and the engagement member 26 is also selectively movable to be adjacent to, or in register with, the recessed portion 31′ or 31″. The recessed portion 31′ or 31″ is configured such that the engagement member 26 is unbiased, that is not biased, towards the disk 24′ or 24″ when adjacent the recessed portion 31′ or 31″, as seen for example in FIG. 17 for the recessed portion 31′. This can happen if the engagement member 26 is spaced apart from the recessed portion 31′, or if the engagement member 26 engages the recessed portion only through its weight, among other possibilities.

In operation, a spool 14 on which fishing line 12 to transfer to a reel 16 is enrolled is inserted on the support shaft 20 and locked thereto using the spool lock 86. The holder 10 can then be mounted to the fishing rod 18 to which the reel 16 is mounted using the mount 72, and the reel 16 is turned to transfer the fishing line 12 thereto. The tension under which the transfer occurs can be adjusted by screwing more or less the adjustment member 36 in the support member 34, and, in the holders 10′ and 10″, transferring the engagement member 26 between the corrugated surfaces 28′ and 29′ or 28″ and 29″. When the transfer is completed, the mount 72 is released to remove the holder 10 from the fishing rod 18, and the spool lock 86 can be removed from the support shaft 20 to remove the used spool 14 therefrom.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A holder for assisting in transferring fishing line held on a spool to a reel supported by a fishing rod, the holder comprising:
a support shaft for supporting the spool so that the spool and the support shaft are jointly axially rotatable; and
a brake operatively coupled to the support shaft for applying a rotational drag to the support shaft when the support shaft is rotated;
wherein the brake includes a disk jointly rotatable with the support shaft and an engagement member operatively coupled to the disk to resist rotation of the disk.

2. The holder as defined in claim 1, wherein the engagement member mechanically engages the disk.

3. The holder as defined in claim 2, wherein the disk is provided with a corrugated surface defining corrugations and the engagement member engages the corrugated surface.

4. The holder as defined in claim 3, wherein the engagement member is urged towards the corrugated surface.

5. The holder as defined in claim 3, wherein the engagement member is biased towards the corrugated surface by a biasing element.

6. The holder as defined in claim 5, wherein a biasing force biasing the engagement member towards the corrugated surface is adjustable.

7. The holder as defined in claim 3, wherein the engagement member is mounted to a support member, the engagement member being movable relative to the support member perpendicularly to the corrugated surface to follow the corrugations as the disk is rotated with the support member remaining at a fixed distance from the disk.

8. The holder as defined in claim 7, further comprising an adjustment member mounted to the support member and a biasing element extending between the adjustment member and the engagement member, wherein moving the adjustment member relative to the support member changes a biasing force exerted by the biasing element on the engagement member and biasing the engagement member towards the corrugated surface.

9. The holder as defined in claim 7, wherein the corrugated surface is a first corrugated surface, the disk further defining a second corrugated surface having different corrugation characteristics than the first corrugated surface, the support member being movable relative to the disk to engage the engagement member with a selected one of the first and second corrugated surfaces.

10. The holder as defined in claim 9, wherein the disk is mounted in an enclosure, the enclosure defining a groove receiving the support member such that the support member is movable along the groove to move the engagement member in contact with the selected one of the first and second corrugated surfaces.

11. The holder as defined in claim 7, wherein the engagement member includes a pin, the support member includes a sleeve defining a passageway extending therethrough, the passageway being at least in part threaded, the biasing element includes a coil spring and the adjustment member includes a threaded section configured for threadedly engaging the passageway, the pin and adjustment members being mounted in the sleeve at opposed sleeve ends thereof with the coil spring provided therebetween.

12. The holder as defined in claim 3, wherein the disk defines a pair of parallel side surfaces and an edge surface extending therebetween, the corrugated surface being defined on one of the side surfaces.

13. The holder as defined in claim 3, wherein the disk defines a pair of parallel side surfaces and an edge surface extending therebetween, the corrugated surface being defined on the edge surface.

14. The holder as defined in claim 1, further comprising a mount for mounting the holder to the fishing rod.

15. The holder as defined in claim 14, wherein the mount includes a clamp.

16. The holder as defined in claim 1, further comprising a spool lock mountable to the support shaft for locking the spool thereto.

17. The holder as defined in claim 16, wherein the support shaft includes a threaded section and the spool lock is screwable on the threaded section.

18. The holder as defined in claim 17, wherein the spool lock further includes a release mechanism for disengaging the spool lock from the threaded section and allowing longitudinal movement of the spool lock along the threaded section.

19. The holder as defined in claim 1, wherein the disk defines a recessed portion, the engagement member being selectively movable between adjacent the corrugated surface and adjacent the recessed portion, wherein the recessed portion is configured such that the engagement member is unbiased towards the disk when adjacent the recessed portion.

20. The holder as defined in claim 19, wherein the recessed portion is configured such that the engagement member is disengaged from the disk when adjacent the recessed portion.
